(19) United States
(12) Patent Application Publication
(10) Pub. No.: US 2004/0190793 A1
(43) Pub. Date: Sep. 30, 2004

(54) Method for retrieving images by content measure metadata encoding

(76) Inventors: Mark E. Rorvig, Denton, TX (US); Tai Jeong Ki, Carrollton, TX (US)

Correspondence Address: WILLIAMS, MORGAN & AMERSON, P.C., 10333 RICHMOND, SUITE 1100, HOUSTON, TX, 77042, US

(21) Appl. No.: 10/087,347

(22) Filed: Mar. 1, 2002

(51) Int. Cl. G06K 9/46

(52) U.S. Cl. 382/305; 382/239; 382/170; 382/165

(57) ABSTRACT

The present invention provides a method for retrieving images by content measure metadata encoding. The method includes measuring selected features of a first object to form a first measurement information, encoding the first measurement information in metadata elements of a first hypertext markup language (HTML) document comprising a link to the first object, measuring selected features of a second object to form a second measurement information, encoding the second measurement information in metadata elements of a second hypertext markup language (HTML) document comprising a link to the second object, and retrieving the second object in response to the difference between the first measurement information of the first HTML document and the second measurement information of the second HTML document being less than or equal to a threshold difference value.

### BACKGROUND OF THE INVENTION

1. Field of the Invention

This invention relates generally to image retrieval, and, more particularly, to image retrieval by content measure metadata coding.

2. Description of the Related Art

The field of image retrieval has gained momentum over recent years due, at least in part, to a dramatic increase in the volume of digital images. Digital imaging has crept into the mainstream cyber-culture as a result of increasing popularity with digital imaging equipment and decreasing memory costs. Additionally, Internet bandwidth has increased substantially such that digital images can more easily be transferred to remote sites via the World Wide Web. As the number of digital images has increased, a need for efficient and practical methods to browse, search, and retrieve images has arisen.

Early image retrieval techniques focused on text-based management and retrieval of images. One early framework of image retrieval focused on annotating the images by text and then using a text-based database management system (“DBMS”) to retrieve images. Advances in database design, such as data modeling, multi-dimensional indexing, and query evaluation, to name a few, have provided improved techniques for implementing DBMS. However, notwithstanding these improvements, DBMS suffers from two major difficulties, especially with relatively large image collections. DBMS generally requires manual image annotation, which, depending on the size of an image collection, may require vast amounts of physical labor. More importantly, these annotations of the images may be subjective to the human perception of the annotator. In other words, for the same image content, one person may perceive the image differently from another. Accordingly, the impreciseness of the annotations due to human subjectivity of the image content may cause substantial mismatches in retrieval processes, thereby resulting in impractical image retrieval systems.

As DBMS grew more impractical due to the emergence of large-scale image collections, content-based image retrieval (CBIR) techniques were proposed. Instead of being manually annotated by text-based keywords, CBIR allows images to be indexed by their own visual content, such as color, shape, and texture, among other qualities. Accordingly, one of the major difficulties of content-based image retrieval lies in deciding which image features (i.e., content) to extract from the image. Although many image features may be extracted, there is generally no optimal ones that lead to perfect retrieval, but some features may produce more accurate results than others.

A practical CBIR system provides a variety of search queries such that a user can retrieve the desired images from an image collection. The search queries may be linked to the features extracted from the image, such as color, shape, and texture. Among other queries, a user may need to search for images in the collection similar to an image exemplar. Many image collections contain few or no index terms. Accordingly, there is a need for efficient and practical techniques to retrieve the images similar to the image exemplar. Additionally, many image collections are available for search and retrieval on the World Wide Web. As such, there is also a need to catalogue and retrieve images efficiently on the Internet. The present invention is directed to overcoming, or at least reducing the effects of, one or more of the problems set forth above.

### SUMMARY OF THE INVENTION

In one aspect of the present invention, a method is provided for retrieving images by content measure metadata encoding. The method includes measuring selected features of a first object to form a first measurement information, encoding the first measurement information in metadata elements of a first hypertext markup language (HTML) document comprising a link to the first object, measuring selected features of a second object to form a second measurement information, encoding the second measurement information in metadata elements of a second hypertext markup language (HTML) document comprising a link to the second object, and retrieving the second object in response to the difference between the first measurement information of the first HTML document and the second measurement information of the second HTML document being less than or equal to a threshold difference value.

In another aspect of the present invention, a system is provided for retrieving images by content measure metadata encoding. The system includes means for measuring selected features of a first object to form a first measurement information, means for encoding the first measurement information in metadata elements of a first hypertext markup language (HTML) document comprising a link to the first object, means for measuring selected features of a second object to form a second measurement information, means for encoding the second measurement information in metadata elements of a second hypertext markup language (HTML) document comprising a link to the second object, and means for retrieving the second object in response to the difference between the first measurement information of the first HTML document and the second measurement information of the second HTML document being less than or equal to a threshold difference value.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a block diagram of an object in accordance with one embodiment of the present invention;

FIG. 2 illustrates a flow diagram of a method in accordance with one embodiment of the present invention;

FIG. 3 illustrates an exemplary block diagram of the object in FIG. 1, in accordance with one embodiment of the present invention;

FIG. 4 illustrates an exemplary histogram of the object in FIG. 3, in accordance with one embodiment of the present invention;

FIG. 5 illustrates an exemplary histogram of the object in FIG. 3, in accordance with one embodiment of the present invention;

FIG. 6 illustrates an exemplary histogram of the object in FIG. 3, in accordance with one embodiment of the present invention;

FIG. 7 illustrates an exemplary histogram of the object in FIG. 3, in accordance with one embodiment of the present invention;

FIG. 8 illustrates an exemplary histogram of the object in FIG. 3, in accordance with one embodiment of the present invention;

FIG. 9 illustrates an exemplary histogram of the object in FIG. 3, in accordance with one embodiment of the present invention;

FIG. 10 illustrates a method of estimating the area under a histogram of FIGS. 4-9, in accordance with one embodiment of the present invention;

FIG. 11 illustrates an exemplary hypertext markup language (“HTML”) document in accordance with one embodiment of the present invention;

FIGS. 12A-12B illustrate a flow diagram of a method in accordance with one embodiment of the present invention; and

FIG. 13 illustrates a block diagram of a computer system programmed and operated in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

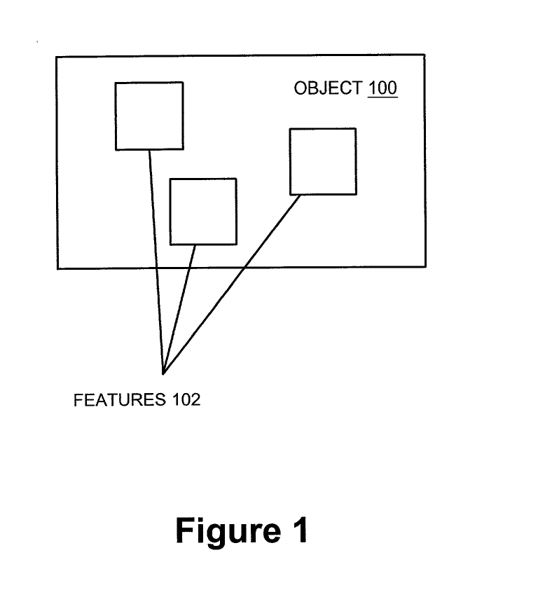

FIG. 1 is a diagram of an object 100 including organized data (i.e., information). Such organized data may be in the form of, for example, image data, text data, or sound data. As indicated in FIG. 1, the object 100 includes multiple features 102. As used herein, the term “feature” refers to a detectable pattern. For example, the object 100 may include image data. Detectable patterns in the image data may include, for example, variations in color and/or intensity. Such variations may represent, for example, shapes, corners, edges, etc. Alternatively, the object 100 may include text data. Detectable patterns in the text data may include, for example, strings of symbols or characters (i.e., “text tokens”). Such strings of symbols or characters may form words, or word strings (i.e., phrases). Where the object 100 includes sound data, detectable patterns in the sound data may include, for example, variations in frequency and/or amplitude. The object 100 may include live data, such as a live image or a live sound capture, which can be used for face and voice recognition, retina scanning, or fingerprint analysis, for example.

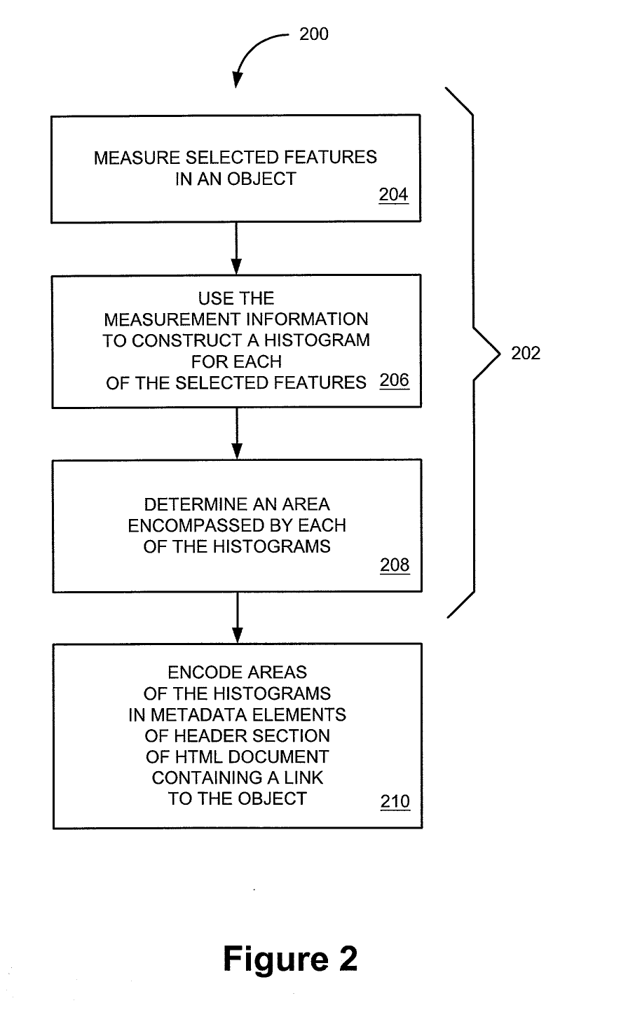

FIG. 2 is a flow chart of a method 200 for encoding numerical values, indicative of frequencies of selected features in an object, in a container (e.g., a document) that either contains the object, or has a link to the object. The object may be, for example, the object 100 of FIG. 1, and the selected features may be a subset of the features 102 of FIG. 1. The container may be, for example, a hypertext markup language (HTML) document having a link to the object. The method 200 includes a method 202 for generating the numerical values indicative of frequencies of selected features in the object.

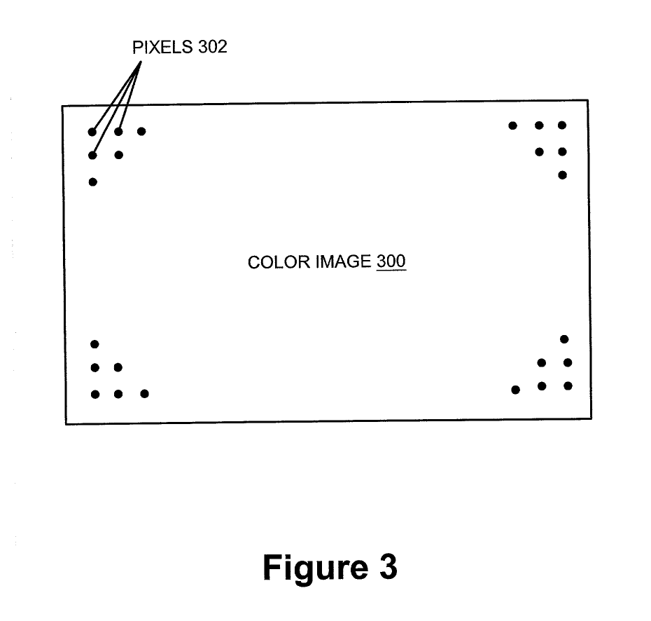

FIGS. 3-11 will be used to illustrate the operations of the methods 200 and 202. FIG. 3 is a diagram of an exemplary embodiment of the object 100 of FIG. 1: a color image 300 including multiple picture elements (pixels) 302. The multiple pixels 302 of the color image 300 may convey red, green, or blue color information, as well as gray scale information. The multiple pixels 302 also convey edge information of shapes in the color image 300. Such edge information may include, for example, line length information, line distance information, and line angle information. For example, one or more line segments may be detectable in the color image 300. Line length information corresponding to a given line segment may convey a length of the line segment. Line distance information corresponding to the line segment may convey a distance between a point in the line segment and a selected point in the color image 300 (e.g., an origin). Line angle information corresponding to the line segment may convey an angle formed between a first line passing through the point in the line segment and the origin, and a second reference or axis line also passing through the origin.

It should be appreciated that the present discussion regarding selected features of the color image 300 is not exhaustive and conveys only one embodiment. For example, other embodiments of the color image 300 may include pixels conveying colors other than the ones described above. Other embodiments of the color image 300 may include pixels conveying any of a variety of selected features, in accordance with conventional practice.

Referring back to FIG. 2, during an operation 204 of the methods 200 and 202, selected features of the object 100 are measured. Referring to FIG. 3, the pixels 302 of the color image 300 may each have, for example, measurable intensity values for the colors red, green, and blue (e.g., ranging from 0 to 255). Each of the pixels 302 may also have a measurable gray scale intensity value (e.g., ranging between 0 and 255). The pixels 302 may define detectable line segments, and these line segments may have measurable line lengths, line distances, and line angles. Thus, where the object 100 is the color image 300 of FIG. 3, the selected features may be a subset of: the intensities for the colors red, green, blue, and gray, line lengths, line distances, and line angles.

During an operation 206 of the methods 200 and 202 of FIG. 2, the measurement information obtained during the operation 204 is used to construct a histogram for each of the selected features. In common fashion, a histogram for a selected feature may be constructed by determining a range of the selected feature, dividing the range into equally-sized intervals, counting the number of measurements (i.e., frequencies of the selected feature) in each of the intervals, and forming a plot of the data wherein the frequency of the selected feature is along the y-axis, and the interval divisions of the range of the selected feature are along the x-axis. In the histogram, the number of measurements in each interval is represented by a height of a rectangle positioned above the interval.

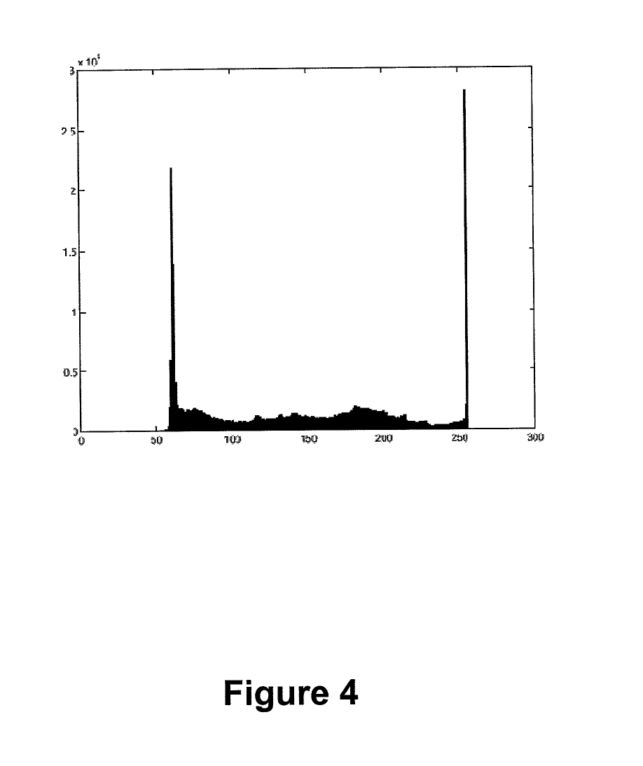

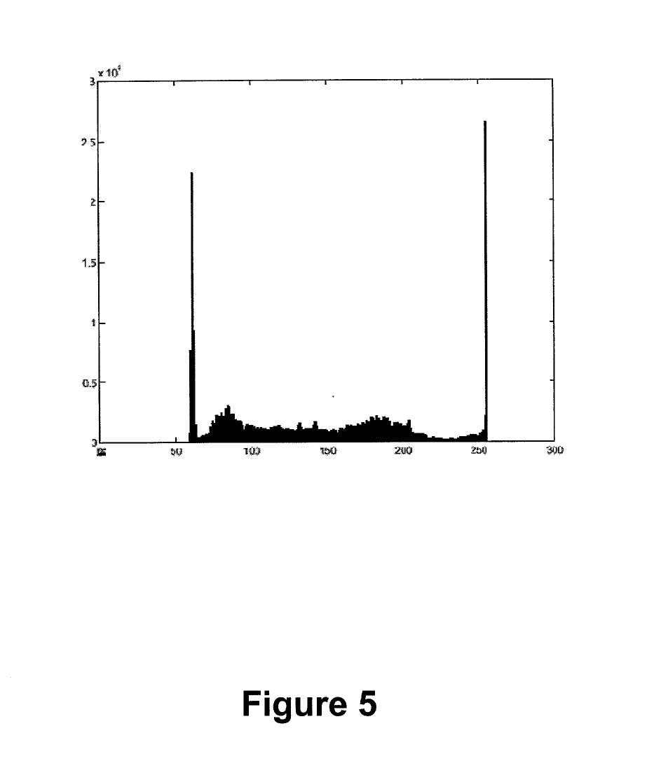

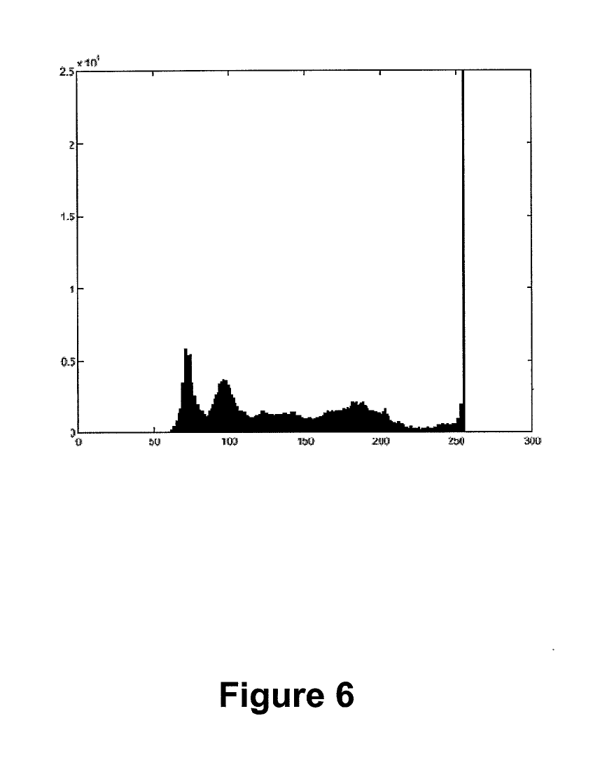

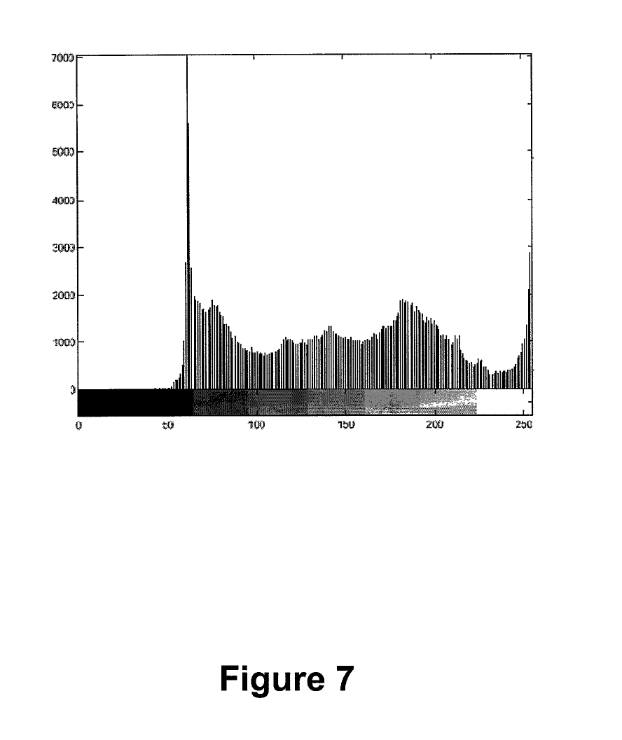

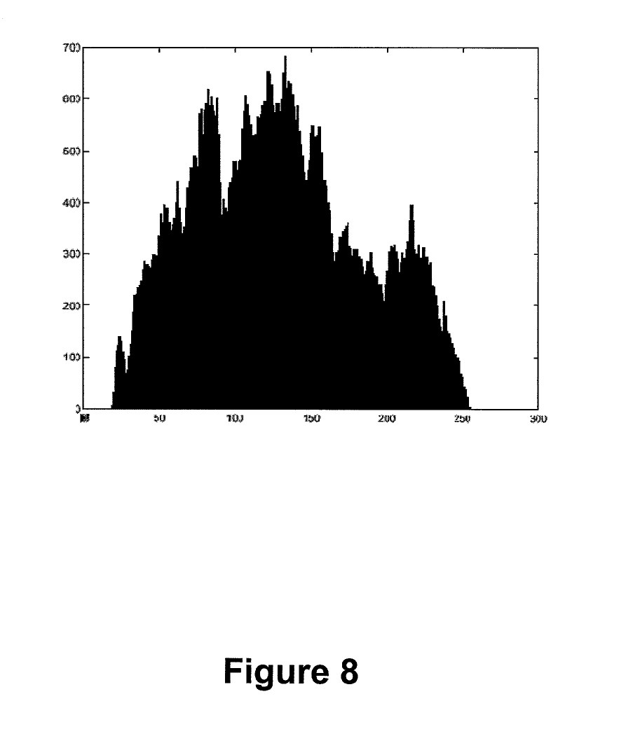

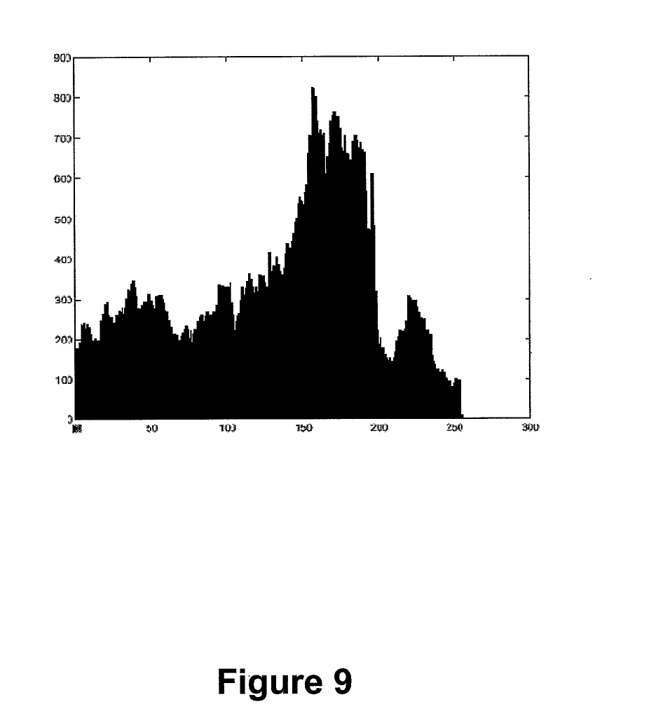

FIG. 4 is an exemplary histogram of the intensities of the color red in the pixels 302 of the color image 300 of FIG. 3. FIG. 5 is an exemplary histogram of the intensities of the color green in the pixels 302 of the color image 300 of FIG. 3, and FIG. 6 is an exemplary histogram of the intensities of the color blue in the pixels 302 of the color image 300 of FIG. 3. FIG. 7 is an exemplary histogram of the intensities of the color gray in the pixels 302 of the color image 300 of FIG. 3. FIG. 8 is an exemplary histogram of the line distances defined by the pixels 302 of the color image 300 of FIG. 3, and FIG. 9 is an exemplary histogram of the line angles defined by the pixels 302 of the color image 300 of FIG. 3.

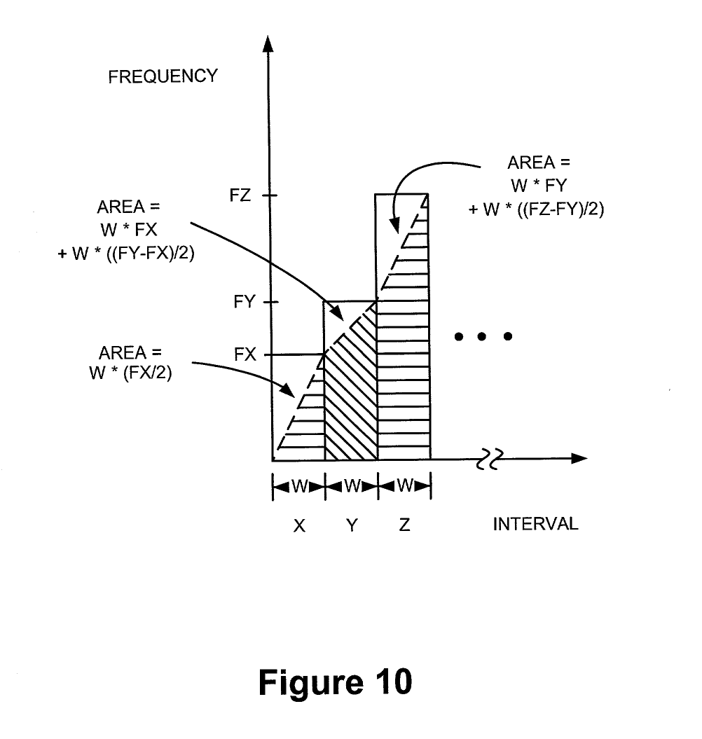

During an operation 208 of the methods 200 and 202 of FIG. 2, an area encompassed by (i.e., “under”) each of the histograms is determined. FIG. 10 depicts one method which may be used to estimate an area under a histogram. In the method of FIG. 10, the intervals are arranged in order along the x-axis, beginning with the smallest frequency and increasing (i.e., ascending) to the largest frequency. The intervals have sizes (i.e., widths) “w.” A piecewise linear curve is formed through the intervals as shown in FIG. 10. In FIG. 10, an interval “x” has a frequency “Fx,” and the area under the histogram in interval “x” is approximated as: AREA(x)=w·(Fx/2). An interval “y” has a frequency “Fy,” which is greater than the frequency “Fx,” and the area under the histogram in interval “y” is approximated as: AREA(y)=w·Fx+w·((Fy−Fx)/2)=w·(Fx+((Fy−Fx)/2)). An interval “z” has a frequency “Fz,” which is greater than the frequency “Fy,” and the area under the histogram in interval “z” is approximated as: AREA(z)=w·Fy+w·((Fz−Fy)/2)=w·(Fy+((Fz−Fy)/2)). The total area under the histogram in intervals “x,” “y,” and “z” is approximated as: AREA=w·((Fx+Fy)+(Fz/2)).

It is noted that by arranging the “n” intervals of a histogram, where n≧2, in order along the x-axis, beginning with the smallest frequency and increasing (i.e., ascending) to the largest frequency, and renumbering the intervals from left to right starting with “1,” the following equation may be advantageously used to approximate the area encompassed by (i.e., “under”) the histogram:

$$AREA = w \cdot ( ( {\sum }_{i = 1}^{n - 1} Fi ) + \frac{Fn}{2} )$$

It is noted that the area encompassed by (i.e. “under”) the histogram of a selected feature is a numerical value indicative of the frequency of the selected feature in the object. As described below, such numerical values may be useful when comparing one object to another to determine a measure of similarity between the objects.

The Lorenz information measure (“LIM”), widely used in economics, effectively divides the above approximated area under a histogram having “n” intervals by the quantity

$$\begin{matrix}( 2 \cdot {\sum }_{i = 1}^{n} Fi ) \text{:} & \\ & LIM = \frac{w \cdot ( ( {\sum }_{i = 1}^{n - 1} Fi ) + \frac{Fn}{2} )}{( 2 \cdot {\sum }_{i = 1}^{n} Fi )}\end{matrix}$$

dividing the approximated area under the histogram by the quantity

$$( 2 \cdot {\sum }_{i = 1}^{n} Fi )$$

tends to normalize the approximated area. This normalization function is considered an enhancement when comparing objects to determine a degree of similarity between the objects. Thus, during the operation 208 of the methods 200 and 202 of FIG. 2, the areas encompassed by (i.e., “under”) the histograms may be used to determine Lorenz information measures (“LIMs”) for the corresponding selected features.

During a step 210 of the method 200 of FIG. 2, the areas of the histograms are encoded in metadata elements of a header section of a hypertext markup language (“HTML”) document containing a link to the object. As described above, the areas under the histograms may be used to determine LIMs for the corresponding selected features, and the LIMs may be encoded in the metadata elements of the header section of the HTML document.

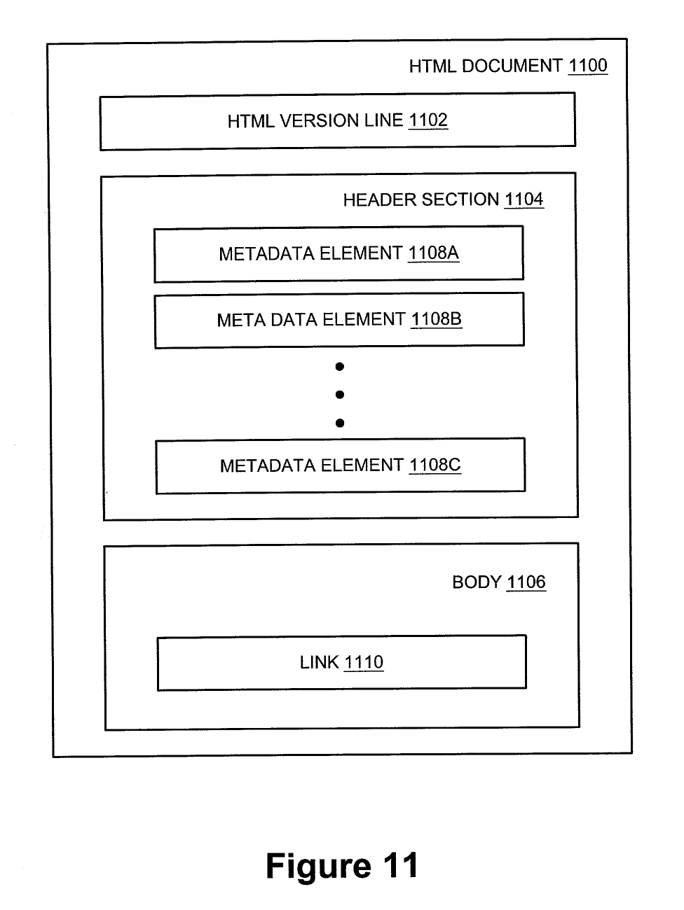

FIG. 11 is a diagram of an exemplary hypertext markup language (“HTML”) document 1100. In the embodiment of FIG. 11, the HTML document 1100 includes an HTML version line 1102, a header section 1104, and a body 1106. The HTML version line 1102 contains information indicative of a version of the hypertext markup language used to form the HTML document 1100. The header section 1104 includes metadata elements 1108A, 1108B, and 1108C. Each of the metadata elements 1108 may include a value, obtained using the method 202 of FIG. 2, for one of the selected features (i.e., a value indicative of an area under a histogram corresponding to the selected feature, such as a LIM). As indicated in FIG. 11, the body 1106 includes a link 1110 (e.g., a “pointer”) to an object (e.g., the color image 300 of FIG. 3).

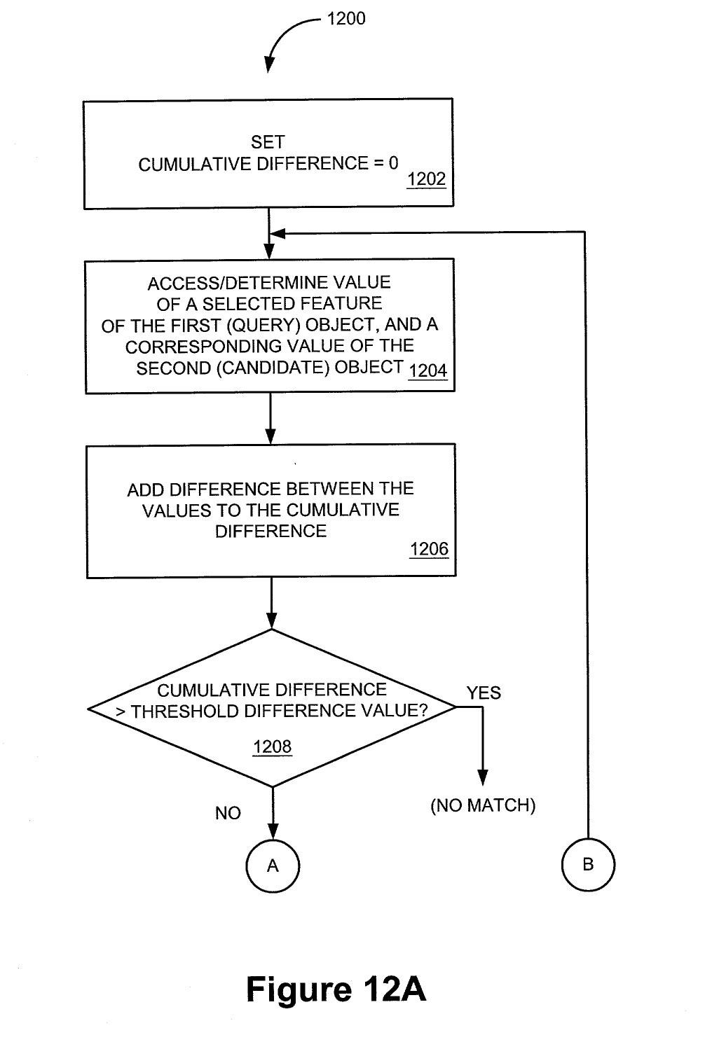

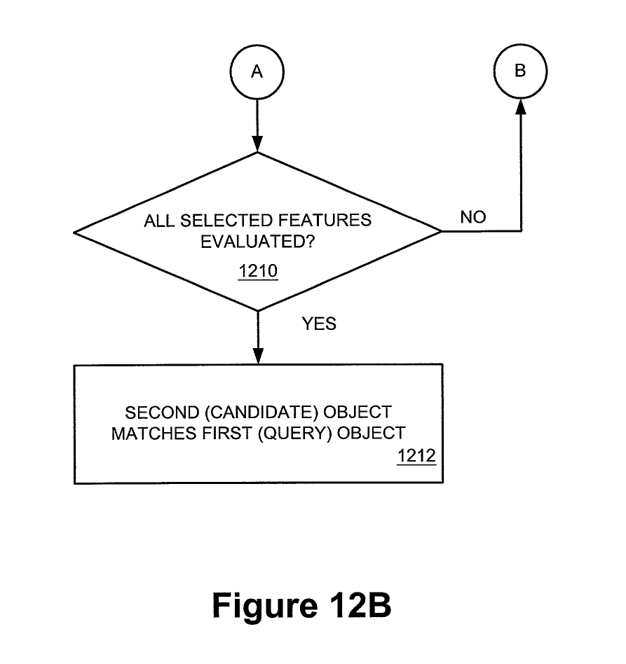

FIGS. 12A-12B, in combination, form a flow chart of one embodiment of a method 1200 for determining a measure of similarity between a first (query) object and a second (candidate) object. In a first operation 1202 of the method 1200, a cumulative difference value is set to zero. During an operation 1204, a value corresponding to a selected feature of the first (query) object is either determined (e.g., using the method 202 of FIG. 2 described above) or accessed. For example, a first HTML document may contain a link to the first (query) object, and the first HTML document may include metadata elements corresponding to the first (query) object. In this situation, the first HTML document may be accessed to obtain the value of the selected feature of the first (query) object.

The corresponding value of the second (candidate) object is also either determined (e.g., using the method 202 of FIG. 2 described above) or accessed. For example, a second HTML document may contain a link to the second (candidate) object, and the second HTML document may include metadata elements corresponding to (i.e., “of”) the second (candidate) object. In this situation, the second HTML document may be accessed to obtain the value of the selected feature of the second (candidate) object.

During an operation 1206, a difference (e.g., an absolute difference) between the values of the first (query) object and the second (candidate) object is added to the cumulative difference value. During a decision operation 1208, the cumulative difference value is compared to a threshold difference value. If the cumulative difference value is greater than the threshold difference value, the second (candidate) object is determined not to be highly similar to (i.e., not to “match”) the first (query) object. On the other hand, if the cumulative difference value is less than or equal to the threshold difference value, a decision operation 1210 is performed as shown in FIG. 12B.

It should be appreciated that the threshold difference value may be determined in any of a variety of ways, in accordance with conventional practice. Applications that may require more detailed comparisons generally comprise lower threshold numbers. The threshold value may be predetermined by a computer or it may be entered by a human in real time, as part of the search criteria, for example.

During the decision operation 1210, a determination is made as to whether all of the selected features have been evaluated. If all of the selected features have not been evaluated, the operations 1204, 1206, and 1208 are repeated. On the other hand, if all of the selected features have been evaluated, the second (candidate) object is determined to be highly similar to (i.e., to “match”) the first (query) object, as indicated in the operation 1212 of FIG. 12B.

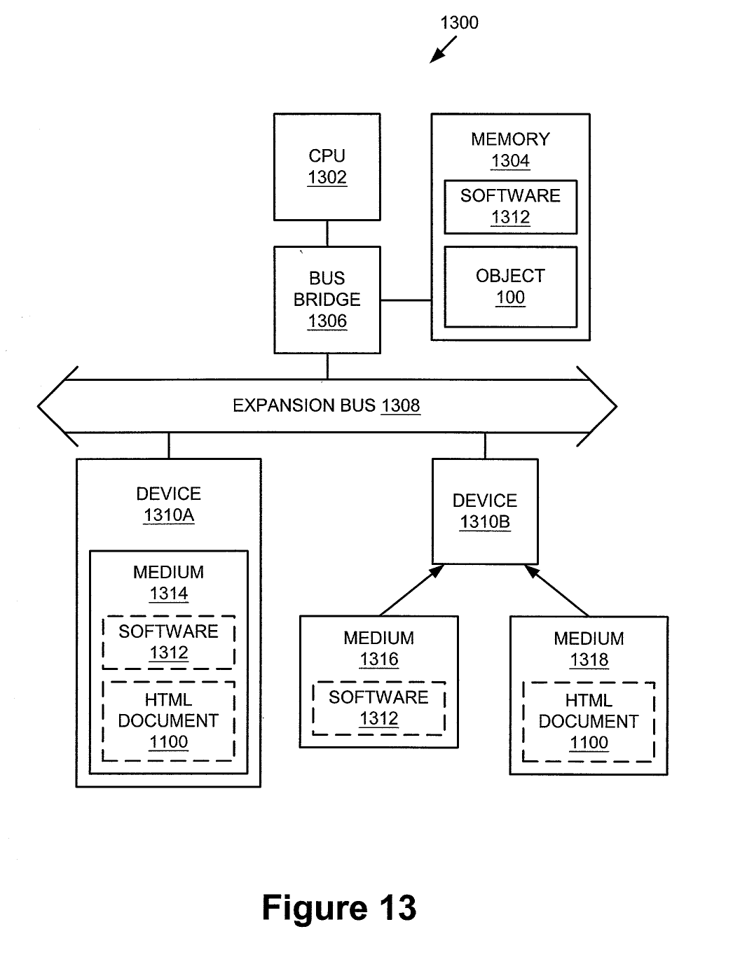

FIG. 13 is a diagram of one embodiment of a computer system 1300 that can function as an information retrieval system. In the embodiment of FIG. 13, the computer system 1300 includes a central processing unit (“CPU”) 1302 and a memory 1304 coupled to a bus bridge 1306. The bus bridge 1306 is coupled to an expansion bus 1308 (e.g., a peripheral component interconnect (“PCI”) bus, an industry standard architecture (“ISA”) bus, etc.). The bus bridge 1306 translates signals between the CPU 1302, the memory 1304, and the expansion bus 1308.

During operation, the CPU 1302 obtains instructions and data from the memory 1304, and executes the instructions. In the embodiment of FIG. 13, the software 1312 and the object 100 of FIG. 1 reside in the memory 1304. The software 1312 includes instructions executable by the CPU 1302, and embodies the method 202 of FIG. 2, and the method 1200 of FIGS. 12A-12B. It should be appreciated that the software 1312 may also embody the method 200 of FIG. 2. When the computer system 1300 is functioning as an information retrieval system, the CPU 1302 accesses instructions from the software 1312, and data from the object 100.

In the embodiment of FIG. 13, two input/output devices 1310A and 1310B are coupled to the expansion bus 1308. The device 1310A includes a fixed medium 1314 for storing data (e.g., a fixed magnetic medium), wherein the data may include instructions. The device 1310A may be, for example, a hard disk drive. As indicated in FIG. 13, the software 1312 and the hypertext markup language (“HTML”) document 1100 of FIG. 11 may be stored on the fixed medium 1314.

The object 100 may represent, for example, the first (query) object described above with regard to FIGS. 12A-12B. The link 1110 of the HTML document 1100 may be, for example, a link to the second (candidate) object described above, and the metadata elements 1108 in the header section 1 104 of the HTML document 1 100 may include values indicative of areas under histograms (e.g., Lorenz information measures or LIMs) corresponding to selected features of the second (candidate) object. When the computer system 1300 is functioning as an information retrieval system, the software 1312 and the object 100 may be copied from the fixed medium 1314 to the memory 1304.

The device 1310B is configured to receive data, including instructions, from media 1316 and/or 1318. The device 1310B may be, for example, a floppy disk drive, or a compact disk read only memory (“CD-ROM”) drive. In this situation, the medium 1316 and/or the medium 1318 may be a portable medium (e.g., a carrier medium) such as a floppy disk or a CD-ROM disk. As indicated in FIG. 13, the software 1312 may be stored on the medium 1316, and the HTML document 1100 may be stored on the medium 1318. When the computer system 1300 is functioning as an information retrieval system, the software 1312 may be copied from the medium 1316 to the memory 1304, and the HTML document 1100 may be accessed via the medium 1318. When the HTML document 1100 is accessed, portions of the HTML document 1100 may be copied from the medium 1318 to the memory 1304.

Alternately, the device 1310B may be a modem or a network interface card (“NIC”). In this situation, the medium 1316 and/or 1318 may be the same media. The medium 1316 and/or the medium 1318 may be, for example, a transmission medium, such as a communication line or cable (e.g., a telephone line, a coaxial cable, etc.). During operation, the device 1310B may receive a signal via the transmission medium, wherein the signal conveys data (including instructions) to the device 1310B. When the computer system 1300 is functioning as an information retrieval system, the software 1312 and/or the HTML document 1100 may be conveyed by the signal to the device 1310B. The software 1312 may be copied from the medium 1316 to the memory 1304, and the HTML document 1100 may be accessed via the medium 1318. When the HTML document 1100 is accessed, portions of the HTML document 1100 may be copied from the medium 1318 to the memory 1304.

When the computer system 1300 is functioning as an information retrieval system, the computer system 1300 may carry out the operations of the method 202 of FIG. 2 on the object 100, thereby obtaining values indicative of areas under histograms (e.g., Lorenz information measures or LIMs) corresponding to selected features of the object 100. The computer system 1300 may carry out the operations of the method 1200 of FIGS. 12A-12B, thereby determining a measure of similarity between the object 100 and the second (candidate) object represented by the HTML document 1100.

It is noted that the computer system 1300 may advantageously carry out the operations of the method 1200 of FIGS. 12A-12B to determine a measure of similarity between the object 100 and a second (candidate) object represented by the HTML document 1100 without ever accessing (e.g., downloading) the second (candidate) object. This is highly valuable where the second (candidate) object contains a large amount of data (e.g., is a large image file), and extremely valuable where the object 100 is to be compared to several candidate objects containing large amounts of data (e.g., large image files).

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of retrieving images by content measure metadata encoding, comprising:
retrieving a first object, wherein the first object comprises a first measurement information encoded in metadata elements of a first hypertext markup language (HTML) document;
comparing the first object with a second object, wherein the second object comprises a second measurement information encoded in metadata elements of a second hypertext markup language (HTML) document;
retrieving the second object in response to the difference between the first measurement information of the first HTML document and the second measurement information of the second HTML document being less than or equal to a threshold difference value.

2. A method of retrieving images by content measure metadata encoding, comprising:
measuring selected features of a first object to form a first measurement information;
encoding the first measurement information in metadata elements of a first hypertext markup language (HTML) document comprising a link to the first object;
measuring selected features of a second object to form a second measurement information;
encoding the second measurement information in metadata elements of a second hypertext markup language (HTML) document comprising a link to the second object; and
retrieving the second object in response to the difference between the first measurement information of the first HTML document and the second measurement information of the second HTML document being less than or equal to a threshold difference value.

3. A method of encoding images by content measure metadata encoding, comprising:
measuring selected features of an object to form measurement information;
constructing a histogram for each of the selected features using the measurement information;
determining an area encompassed by each of the histograms; and
encoding areas of the histograms in metadata elements of a hypertext markup language (HTML) document.

4. A method of claim 3, wherein measuring selected features further comprises measuring an intensity of a preselected color of the object.

5. A method of claim 4, wherein measuring the intensity of the preselected color further comprises measuring the intensity of a color red.

6. A method of claim 4, wherein measuring the intensity of the preselected color further comprises measuring intensity of the color green.

7. A method of claim 4, wherein measuring the intensity of the preselected color further comprises measuring intensity of the color blue.

8. A method of claim 4, wherein measuring the intensity of the preselected color further comprises measuring intensity of the color gray.

9. A method of claim 4, wherein measuring selected features further comprises measuring a geometric feature of the object.

10. A method of claim 9, wherein measuring the geometric feature further comprises measuring a line distance.

11. A method of claim 9, wherein measuring the geometric feature further comprises measuring a line angle.

12. A method of claim 3, wherein constructing the histogram comprises constructing an x-axis representing interval divisions of the selected feature and a y-axis representing a frequency of the selected feature.

13. A method of claim 3, further comprising converting the area under the histogram to a Lorenz Information Measure (LIM).

14. A method of claim 3, further comprising associating a link to the object in the HTML document.

15. A method of retrieving images by content measure metadata encoding, comprising:
measuring selected features of a first object to form a first measurement information;
constructing a first histogram for each of the selected features using the first measurement information;
determining a first area encompassed by each of the first histograms;
encoding the first areas of the first histograms in metadata elements of a first hypertext markup language (HTML) document;
measuring selected features of a second object to form a second measurement information;
constructing a second histogram for each of the selected features using the second measurement information;
determining a first area encompassed by each of the first histograms;
encoding the first areas of the first histograms in metadata elements of a first hypertext markup language (HTML) document; and
retrieving the second object in response to the difference between first measurement information of the first HTML document and the second measurement information of the second HTML document being less than or equal to a threshold difference value.

16. A method of claim 15, wherein measuring selected features further comprises measuring an intensity of a preselected color of the object.

17. A method of claim 16, wherein measuring the intensity of the preselected color further comprises measuring the intensity of a color red.

18. A method of claim 16, wherein measuring the intensity of the preselected color further comprises measuring the intensity of a color green.

19. A method of claim 16, wherein measuring the intensity of the preselected color further comprises measuring the intensity of a color blue.

20. A method of claim 16, wherein measuring the intensity of the preselected color further comprises measuring the intensity of a color gray.

21. A method of claim 15, wherein measuring selected features further comprises measuring a geometric feature of the object.

22. A method of claim 21, wherein measuring the geometric feature further comprises measuring a line distance.

23. A method of claim 21, wherein measuring the geometric feature further comprises measuring a line angle.

24. A method of claim 15, wherein constructing the histogram comprises constructing an x-axis representing interval divisions of the selected feature and a y-axis representing a frequency of the selected feature.

25. A method of claim 15, further comprising converting the area under the histogram to a Lorenz Information Measure (LIM).

26. A method of claim 15, further comprising a link to the object in the HTML document.

27. A system of retrieving images by content measure metadata encoding, comprising:
means for retrieving a first object, wherein the first object comprises a first measurement information encoded in metadata elements of a first hypertext markup language (HTML) document;
means for comparing the first object with a second object, wherein the second object comprises a second measurement information encoded in metadata elements of a second hypertext markup language (HTML) document;
means for retrieving the second object in response to the difference between the first measurement information of the first HTML document and the second measurement information of the second HTML document being less than or equal to a threshold difference value.

28. A system of retrieving images by content measure metadata encoding, comprising:
means for measuring selected features of a first object to form a first measurement information;
means for encoding the first measurement information in metadata elements of a first hypertext markup language (HTML) document comprising a link to the first object;
means for measuring selected features of a second object to form a second measurement information;
means for encoding the second measurement information in metadata elements of a second hypertext markup language (HTML) document comprising a link to the second object; and
means for retrieving the second object in response to the difference between the first measurement information of the first HTML document and the second measurement information of the second HTML document being less than or equal to a threshold difference value.

29. A system of encoding images by content measure metadata encoding, comprising:
means for measuring selected features of an object to form measurement information;
means for constructing a histogram for each of the selected features using the measurement information;
means for determining an area encompassed by each of the histograms; and
means for encoding areas of the histograms in metadata elements of a hypertext markup language (HTML) document.

30. A system of claim 29, wherein measuring selected features further comprises measuring an intensity of a preselected color of the object.

31. A system of claim 30, wherein measuring the intensity of the preselected color further comprises measuring the intensity of a color red.

32. A system of claim 30, wherein measuring the intensity of the preselected color further comprises measuring the intensity of a color green.

33. A system of claim 30, wherein measuring the intensity of the preselected color further comprises measuring the intensity of a color blue.

34. A system of claim 30, wherein measuring the intensity of the preselected color further comprises measuring the intensity of a color gray.

35. A system of claim 29 wherein measuring selected features further comprises measuring a geometric feature of the object.

36. A system of claim 35 wherein measuring the geometric feature further comprises measuring a line distance.

37. A system of claim 35 wherein measuring the geometric feature further comprises measuring a line angle.

38. A system of claim 29 wherein constructing the histogram comprises constructing an x-axis representing interval divisions of the selected feature and a y-axis representing a frequency of the selected feature.

39. A system of claim 29 further comprising means for converting the area under the histogram to a Lorenz Information Measure (LIM).

40. A system of claim 27, further comprising associating a link to the object in the HTML document.

41. A system of retrieving images by content measure metadata encoding, comprising:
means for measuring selected features of a first object to form a first measurement information;
means for constructing a first histogram for each of the selected features using the first measurement information;
means for determining a first area encompassed by each of the first histograms;
means for encoding the first areas of the first histograms in metadata elements of a first hypertext markup language (HTML) document;
means for measuring selected features of a second object to form a second measurement information;
means for constructing a second histogram for each of the selected features using the second measurement information;
means for determining a first area encompassed by each of the first histograms;
means for encoding the first areas of the first histograms in metadata elements of a first hypertext markup language (HTML) document; and
means for retrieving the second object in response to the difference between the first measurement information of the first HTML document and the second measurement information of the second HTML document being less than or equal to a threshold difference value.

42. A system of claim 41, wherein measuring selected features further comprises measuring an intensity of a preselected color of the object.

43. A system of claim 42, wherein measuring the intensity of the preselected color further comprises measuring the intensity of a color red.

44. A system of claim 42, wherein measuring the intensity of the preselected color further comprises measuring the intensity of a color green.

45. A system of claim 42, wherein measuring the intensity of the preselected color further comprises measuring the intensity of a color blue.

46. A system of claim 42, wherein measuring the intensity of the preselected color further comprises measuring the intensity of a color gray.

47. A system of claim 41, wherein measuring selected features further comprises measuring a geometric feature of the object.

48. A system of claim 47, wherein measuring the geometric feature further comprises measuring a line distance.

49. A system of claim 47, wherein measuring the geometric feature further comprises measuring a line angle.

50. A system of claim 41, wherein constructing the histogram comprises constructing an x-axis representing interval divisions of the selected feature and a y-axis representing a frequency of the selected feature.

51. A system of claim 41, further comprising means for converting the area under the histogram to a Lorenz Information Measure (LIM).

52. A system of claim 41, further comprising associating a link to the object in the HTML document.
